(19) United States
(12) Patent Application Publication
(10) Pub. No.: US 2020/0117460 A1
(43) Pub. Date: Apr. 16, 2020

(54) MEMORY INTEGRATED CIRCUIT AND PRE-FETCH ADDRESS DETERMINING METHOD THEREOF

(71) Applicant: Shanghai Zhaoxin Semiconductor Co., Ltd., Shanghai (CN)

(72) Inventors: Jie Jin, Shanghai (CN); Zufa Yu, Shanghai (CN); Ranyue Li, Shanghai (CN)

(73) Assignee: Shanghai Zhaoxin Semiconductor Co., Ltd., Shanghai (CN)

(21) Appl. No.: 16/257,048

(22) Filed: Jan. 24, 2019

(30) Foreign Application Priority Data
Oct. 15, 2018 (CN) 201811195141.8

(51) Int. Cl. G06F 9/345; G06F 9/38; G06F 9/50

(52) U.S. Cl. CPC G06F 9/3455; G06F 9/5027; G06F 9/3861; G06F 9/3802

(57) ABSTRACT

A memory integrated circuit and a pre-fetch address determining method thereof are provided. The memory integrated circuit includes an interface circuit, a memory, a memory controller, and a pre-fetch accelerator circuit. The interface circuit receives a normal read request from an external device. When the pre-fetch accelerator circuit receives the normal read request from the interface circuit, the pre-fetch accelerator circuit adds a current address of the normal read request to a training address group as a new training address. The pre-fetch accelerator circuit reorders a plurality of training addresses of the training address group. The pre-fetch accelerator circuit calculates a pre-fetch stride according to the reordered training addresses of the training address group. The pre-fetch accelerator circuit calculates a pre-fetch address of a pre-fetch request according to the pre-fetch stride and the current address.

### CROSS-REFERENCE TO RELATED APPLICATION

This application claims the priority benefit of China application serial no. 201811195141.8, filed on Oct. 15, 2018. The entirety of the above-mentioned patent application is hereby incorporated by reference herein and made a part of this specification.

### BACKGROUND

### Technical Field

The invention relates to an electrical apparatus, particularly, the invention relates to a memory integrated circuit and the pre-fetch address determining method thereof.

### Description of Related Art

A hardware pre-fetching is pre-fetching future possible access data into the cache based on historical information of an access address by the hardware, so that the processor can quickly obtain the data when the data is actually being used. In the circumstance where the processor transmits a plurality of read requests to the random access memory (RAM) in an address-ordered manner, the conventional pre-fetch address determining method may evaluate the effective pre-fetch addresses according the ordered access addresses. However, the present processors may support to access the out-of-order (unordered) addresses. If the processor transmits the plurality of read requests to the random access memory in an address-unordered manner, the estimated accuracy of the conventional pre-fetch address determining method will be reduced.

### SUMMARY

The invention provides a memory integrated circuit and a pre-fetch address determining method thereof to calculate the pre-fetch address of the pre-fetch request.

In one of the exemplary embodiments, the present disclosure is directed to a memory integrated circuit. The memory integrated circuit would include, but not limited to, am interface circuit, a memory, a memory controller, and a pre-fetch accelerator circuit. The interface circuit is configured to receive a normal read request of the external device. The memory controller is coupled to the memory. The pre-fetch accelerator circuit is coupled between the interface circuit and the memory controller, and the pre-fetch accelerator circuit is configured to generate a pre-fetch request. When the pre-fetch accelerator circuit receives the normal read request from the interface circuit, the pre-fetch accelerator circuit adds a current address of the normal read request to a training address group. The pre-fetch accelerator circuit reorders a plurality of training addresses of the training address group. The pre-fetch accelerator circuit calculates a pre-fetch stride according to the plurality of training addresses of the reordered training address group. The pre-fetch accelerator circuit calculates a pre-fetch address of the pre-fetch request according to the pre-fetch stride and the current address.

In one of the exemplary embodiments, the present disclosure is directed to a pre-fetch address determining method for a memory integrated circuit. The pre-fetch address determining method includes: adding, by a pre-fetch accelerator circuit of the memory integrated circuit, a current address of a normal read request to a training address group when the interface circuit of the memory integrated circuit receives the normal read request of an external device; reordering, by the pre-fetch accelerator circuit, a plurality of training addresses of the training address group after the current address is added to the training address group; calculating, by the pre-fetch accelerator circuit, a pre-fetch stride according to the plurality of training addresses of the reordered training address group; and calculating, by the pre-fetch accelerator circuit, a pre-fetch address of a pre-fetch request by the pre-fetch accelerator circuit according to the pre-fetch stride and the current address.

In view of above mentioned, in some embodiments of the present invention, the memory integrated circuit and the pre-fetch address determining method thereof may reorder the training address to calculate the pre-fetch stride and calculate the pre-fetch address according to the pre-fetch stride and the current address. The integrated circuit mentioned in some embodiments can reduce the impact of out-of-order (unordered) addresses on the estimation of the pre-fetch address and improve the pre-fetch hit rate.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a circuit block diagram illustrating a memory integrated circuit according to an embodiment of the disclosure.

FIG. 2 is a flow chart illustrating a pre-fetch address determining method of a memory integrated circuit according to an embodiment of the disclosure.

FIG. 3 is a flow chart illustrating a pre-fetch method of a memory integrated circuit according to an embodiment of the disclosure.

FIG. 4 is a circuit block diagram illustrating a pre-fetch accelerator circuit in FIG. 1 according to an embodiment of the disclosure.

FIG. 5 is a flow chart illustrating the normal request queue 230 operated by the pre-fetch controller 290 shown in FIG. 4 according to an embodiment of the disclosure.

### DESCRIPTION OF THE EMBODIMENTS

The term “coupled to” as used throughout the specification (including the scope of the patent application) may be used to refer to any direct or indirect means of connection. For example, if the description is that the first apparatus is coupled to (or connected) the second apparatus, it should be interpreted such that the first apparatus can be directly connected to the second apparatus, or the first apparatus can be indirectly connected to the second apparatus through other means or a connection means. In addition, where possible, the element/component/step being used the same label in the figures and the implementation methods is the same or similar portion. The same label being used or the same term of the element/component/step being used in different embodiments can be referred to the relative description with each other.

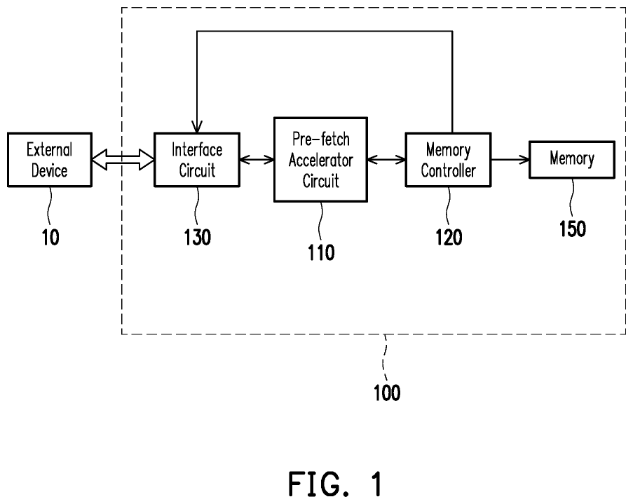

FIG. 1 is a circuit block diagram illustrating a memory integrated circuit according to an embodiment of the disclosure. The memory integrated circuit 100 can be any type of memory integrated circuit 100, depending on design requirements. For example, in some embodiments, the memory integrated circuit 100 may be a Random Access Memory (RAM) integrated circuit, a Read-Only Memory (ROM), or a Flash Memory, other memory integrated circuits, or a combination of one or more types of memory as mentioned above. An external device 10 may include a central processing unit (CPU), a chipset, a direct memory access (DMA) controller, or may be other device having memory access requirements. The external device 10 may transmit an access request to the memory integrated circuit 100. The access request of the external device 10 may include a read request (hereinafter referred to as a normal read request) and/or a write request.

Referring to FIG. 1, the memory integrated circuit 100 includes an interface circuit 130, a memory 150, a memory controller 120, and a pre-fetch accelerator circuit 110. The memory controller 120 is coupled to the memory 150. According to different design requirements, memory 150 can be any type of fixed memory or removable memory. For example, memory 150 may include random access memory (RAM), read only memory (ROM), flash memory, or similar device, or a combination of the above. In the present embodiment, the memory 150 may be a double data rate synchronous dynamic random access memory (DDR SDRAM). The memory controller 120 can be a central processing unit (CPU), a microprocessor, a digital signal processor (DSP), a programmable controller, an application specific integrated circuit (ASIC), or other similar device or a combination of the above.

The interface circuit 130 may receive a normal read request from the external device 10. The interface circuit 130 can be an interface circuit with any communication specification, depending on design requirements. For example, in some embodiments, the interface circuit 130 can be an interface circuit that conforms to the DDR SDRAM busbar specifications. The pre-fetch accelerator circuit 110 is coupled between the interface circuit 130 and the memory controller 120. The interface circuit 130 may transmit the normal read request of the external device 10 to the pre-fetch accelerator circuit 110. The pre-fetch accelerator circuit 110 may transmit the normal read request of the external device 10 to the memory controller 120. The memory controller 120 may execute the normal read request of the external device 10, and take the target data of the normal read request from the memory 150. The memory controller 120 is also coupled to the interface circuit 130. The memory controller 120 may return the target data of the normal read request to the interface circuit 130.

The pre-fetch accelerator circuit 110 may generate a pre-fetch request to the memory controller 120 based on the history information of the normal read request of the external device 10. When the pre-fetch accelerator circuit 110 receives a normal read request from the interface circuit 130, the pre-fetch accelerator circuit 110 may add a current address of the normal read request to a training address group. Next, the pre-fetch accelerator circuit 110 reorders a plurality of training addresses of the training address group. After the reordering is completed, the pre-fetch accelerator circuit 110 calculates a pre-fetch stride based on the plurality of training addresses of the reordered training address group. The pre-fetch accelerator circuit 110 may calculate a pre-fetch address of the pre-fetch request according to the pre-fetch stride and the current address.

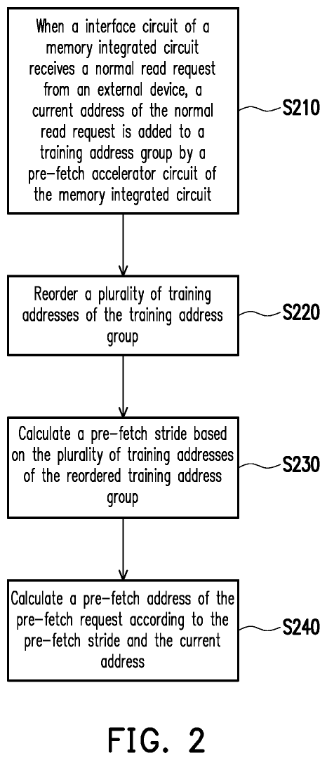

FIG. 2 is a flow chart illustrating a pre-fetch address determining method of a memory integrated circuit according to an embodiment of the disclosure. Referring to FIG. 2, when the interface circuit 130 of the memory integrated circuit 100 receives the normal read request from the external device 10, the pre-fetch accelerator circuit 110 of the memory integrated circuit 100 adds the current address of the normal read request to the training address group (step S210). Then, after the current address is added to the training address group, the pre-fetch accelerator circuit 110 reorders the plurality of training addresses of the training address group (step S220). The pre-fetch accelerator circuit 110 calculates a pre-fetch stride based on the plurality of training addresses of the reordered training address group (step S230). In some embodiments, the pre-fetch accelerator circuit 110 may subtract any two adjacent training addresses in the plurality of training addresses of the reordered training address group to calculate the pre-fetch stride. Then, the pre-fetch accelerator circuit 110 may calculate a pre-fetch address of the pre-fetch request (step S240) according to the pre-fetch stride and the current address of the normal read request.

For example, the pre-fetch accelerator circuit 110 may determine an address variation trend of the normal read request, and then calculate the pre-fetch stride and/or the pre-fetch address according to the address variation trend. In some embodiments, the pre-fetch accelerator circuit 110 may determine the address variation trend of the normal read request according to the variation of the plurality of training addresses of the training address group. For example, the pre-fetch accelerator circuit 110 may find a maximum training address and a minimum training address among the plurality of training addresses of the reordered training address group. The pre-fetch accelerator circuit 110 counts a number of variation times of the maximum training address to obtain a maximum address count value, and count a number of variation times of the minimum training address to obtain a minimum address count value. The pre-fetch accelerator circuit 110 determines an address variation trend of the normal read request according to the maximum address count value and the minimum address count value. For example, when the maximum address count value is greater than the minimum address count value, the pre-fetch accelerator circuit 110 determines that the address variation trend of the normal read request is an incremental trend; when the maximum address count value is less than the minimum address count value, the pre-fetch accelerator circuit 110 determines that the address variation trend of the normal read request is a declining trend.

When the address variation trend of the normal read request is the incremental trend, the pre-fetch accelerator circuit 110 obtains the pre-fetch address from the current address of the normal read request toward a high address direction according to the pre-fetch stride. When the address variation trend of the normal read request is the declining trend, the pre-fetch accelerator circuit 110 obtains the pre-fetch address from the current address of the normal read request toward a low address direction according to the pre-fetch stride. After calculating the pre-fetch address, the pre-fetch accelerator circuit 110 may send a pre-fetch request to the memory controller 120 to obtain the pre-fetch data corresponding to the pre-fetch address.

After the pre-fetch accelerator circuit 110 sends the pre-fetch request to the memory controller 120, the memory controller 120 may execute the pre-fetch request, and take the pre-fetch data corresponding to the pre-fetch request from the memory 150. The memory controller 120 may return the pre-fetch data to the pre-fetch accelerator circuit 110. Therefore, the pre-fetch accelerator circuit 110 may pre-fetch at least one pre-fetch data from the memory 150 through the memory controller 120.

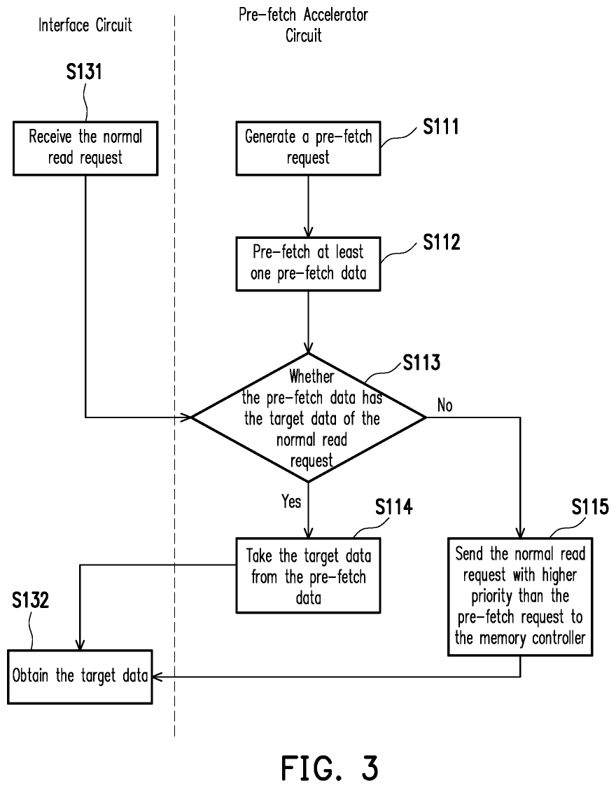

FIG. 3 is a flow chart illustrating a pre-fetch method of a memory integrated circuit according to an embodiment of the disclosure. Please refer to FIG. 1 and FIG. 3. The interface circuit 130 may receive the normal read request of the external device 10 in step S131 and transmit the normal read request of the external device 10 to the pre-fetch accelerator circuit 110. On the other hand, the pre-fetch accelerator circuit 110 can generate a pre-fetch request in step S111. After the pre-fetch accelerator circuit 110 sends the pre-fetch request to the memory controller 120, the pre-fetch accelerator circuit 110 may pre-fetch at least one pre-fetch data from the memory 150 through the memory controller 120 (step S112).

In step S113, the pre-fetch accelerator circuit 110 may determine whether the pre-fetch data in the pre-fetch accelerator circuit 110 has the target data of the normal read request. When the pre-fetch data in the pre-fetch accelerator circuit 110 has the target data required for the normal read request (step S113 is determined to be “Yes”), the pre-fetch accelerator circuit 110 takes the target data from the pre-fetch data and transmits back the target data to the interface circuit 130 (step S114). After the interface circuit 130 obtain the target data of the normal read request, the interface circuit 130 may transmit back the target data to the external device 10 (step S132).

When the pre-fetch data in the pre-fetch accelerator circuit 110 does not have the target data required for the normal read request (step S113 is determined to be “No”), the pre-fetch accelerator circuit 110 prioritizes the normal read request over the pre-fetch request and sends to the memory controller 120 (step S115). The memory controller 120 may execute the normal read request and take the target data of the normal read request from the memory 150. The memory controller 120 may return the target data to the interface circuit 130. After the interface circuit 130 obtains the target data of the normal read request, the interface circuit 130 may return the target data to the external device 10 (step S132).

In addition, in an embodiment, the pre-fetch accelerator circuit 110 determines whether to send a pre-fetch request to the memory controller 120 according to a relationship between status information related to a degree of busyness of the memory controller 120 and a pre-fetch threshold. In an embodiment, the status information includes a count value used to indicate the number of normal read requests that have been delivered to the memory controller 120 but the target data has not been obtained. The pre-fetch threshold is a threshold count value that the pre-fetch accelerator circuit 110 determines whether to send a pre-fetch request. For example, when the count value is greater than the pre-fetch threshold, it means that the memory controller 120 is in a busy state, so the pre-fetch accelerator circuit 110 determines not to send the pre-fetch request to the memory controller 120, so as not to burden the memory controller 120. Conversely, when the count value is less than the pre-fetch threshold, it means that the memory controller 120 is in an idle state, so the pre-fetch accelerator circuit 110 determines that the pre-fetch request can be sent to the memory controller 120. The pre-fetch accelerator circuit 110 may cause the memory controller 120 to execute the normal read request of the external device 10 with high priority, and utilizes the memory controller 120 to perform a pre-fetch request when the memory controller 120 is in an idle state to reduce the probability that the normal read request is delayed.

The pre-fetch threshold can be determined according to design requirements. In an embodiment, the pre-fetch accelerator circuit 110 may count a pre-fetch hit rate. The “pre-fetch hit rate” refers to the statistical value of the target data of the normal read request being the same as the pre-fetch data. The pre-fetch accelerator circuit 110 can dynamically adjust the pre-fetch threshold based on the pre-fetch hit rate. If the pre-fetch hit rate of the pre-fetch accelerator circuit 110 is high, it means that a pre-fetching efficiency of the pre-fetch accelerator circuit 110 is high, so the pre-fetch accelerator circuit 110 may increase the pre-fetch threshold to make the pre-fetch accelerator circuit 110 easier to send a pre-fetch request to the memory controller 120. Conversely, if the pre-fetch hit rate counted by the pre-fetch accelerator circuit 110 is low, it means that the pre-fetch efficiency of the pre-fetch accelerator circuit 110 is low at the time, so the pre-fetch accelerator circuit 110 may lower the pre-fetch threshold so that the pre-fetch accelerator circuit 110 is not easy to send a pre-fetch request to avoid pre-fetching useless data from the memory 150.

Therefore, the pre-fetch accelerator circuit 110 of the disclosure may dynamically adjust the ease of sending the pre-fetch request according to the pre-fetch hit rate in various scenarios, thereby effectively improving the bandwidth utilization of various scenarios. When there is no target data of the normal read request in the pre-fetch data, the interface circuit 130 can send the normal read request with high priority (higher than the pre-fetch request) to the memory controller 120, so that the normal read request can be guaranteed not to be delayed. When the pre-fetch data has the target data of the normal read request, the interface circuit 130 may take the target data from the pre-fetch data without accessing the memory 150, thereby speeding up the reading of the normal read request.

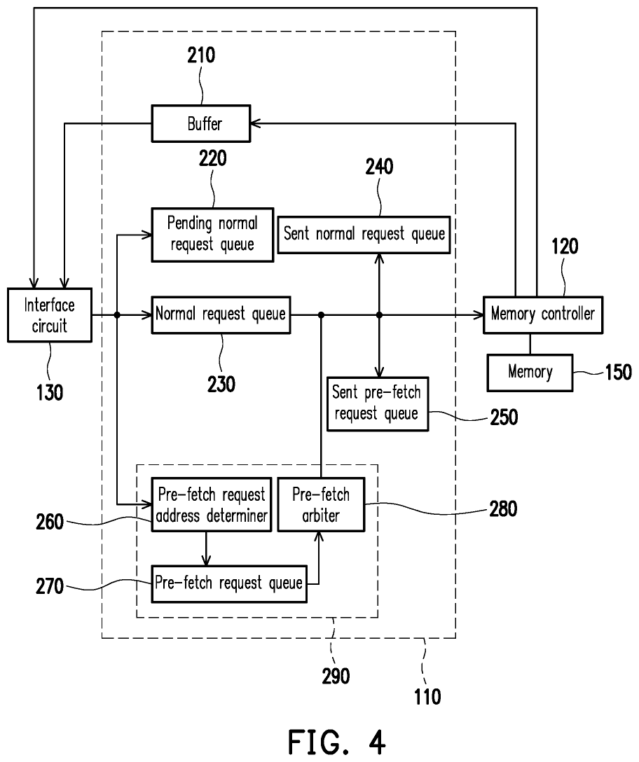

FIG. 4 is a circuit block diagram illustrating a pre-fetch accelerator circuit in FIG. 1 according to an embodiment of the disclosure. In the embodiment shown in FIG. 4, the pre-fetch accelerator circuit 110 includes a buffer 210, a pending normal request queue 220, a normal request queue 230, a sent normal request queue 240, a sent pre-fetch request queue 250 and a pre-fetch controller 290. The pre-fetch controller 290 is coupled between the interface circuit 130 and the memory controller 120. In the process that the interface circuit 130 delivers the normal read request of the external device 10 multiple times, the pre-fetch controller 290 may generate a pre-fetch request to the memory controller 120 based on the history information of the normal read request of the external device 10. For a description of how the pre-fetch controller 290 determines the pre-fetch address of the pre-fetch request, reference may be made to the related description of FIG. 2. Regarding how the pre-fetch controller 290 processes the pre-fetch request and the normal read request of the external device 10, reference may be made to the related description of FIG. 3.

Referring to FIG. 4, the buffer 210 is coupled between the interface circuit 130 and the memory controller 120. The pre-fetch controller 290 may generate a pre-fetch request to the memory controller 120 to read at least one pre-fetch data from the memory 150. The buffer 210 may store the pre-fetch data read from the memory 150.

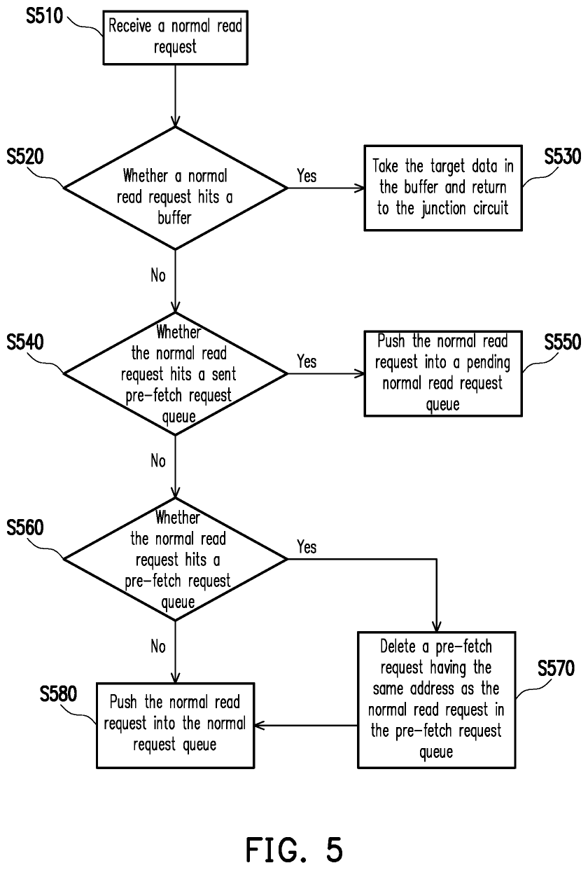

The normal request queue 230 is coupled between the interface circuit 130 and the memory controller 120. The normal request queue 230 may store a normal read request from the interface circuit 130. According to design requirements, the normal request queue 230 can be a first-in-first-out buffer or other type of buffer. An operation of the normal request queue 230 can be referred to the relevant description of FIG. 5.

FIG. 5 is a flow chart illustrating the normal request queue 230 operated by the pre-fetch controller 290 shown in FIG. 4 according to an embodiment of the disclosure. When the pre-fetch controller 290 receives the normal read request of the external device 10 from the interface circuit 130 (step S510), the pre-fetch controller 290 may first check the buffer 210 (step S520). When the normal read request hits the buffer 210 (i.e., the buffer 210 has the target data of the normal read request of the external device 10), the pre-fetch controller 290 may execute step S530 to take the pre-fetch data from the buffer 210. The target data is taken and sent back to the interface circuit 130. When the pre-fetch data stored by the buffer 210 does not have the target data of the normal read request of the external device 10, the pre-fetch controller 290 may check the sent pre-fetch request queue 250 (step S540). When the normal read request hits the sent pre-fetch request queue 250 (that is, the address of the normal read request is the same as the address of the pre-fetch request in the sent pre-fetch request queue 250), the pre-fetch controller 290 may execute Step S550 to push the normal read request of the external device 10 into the pending normal request queue 220. When the normal read request does not hit the sent pre-fetch request queue 250, the pre-fetch controller 290 may check a pre-fetch request queue 270 (step S560). When the normal read request hits the pre-fetch request queue 270 (i.e., the address of the normal read request is the same as the address of a corresponding pre-fetch request in the pre-fetch request queue 270), the pre-fetch controller 290 may execute step S570, to delete the corresponding pre-fetch request in the pre-fetch request queue 270. Regardless of whether the normal read request hits the pre-fetch request queue 270, the pre-fetch controller 290 pushes the normal read request into the normal request queue 230 (step S580). When the normal request queue 230 has a normal read request of the external device 10, the pre-fetch controller 290 sends the normal read request with higher priority than the pre-fetch request to the memory controller 120.

Please refer to FIG. 4. In an embodiment, the pre-fetch controller 290 may determine whether to send a pre-fetch request to the memory controller 120 according to the relationship between the status information related to the degree of busyness of the memory controller 120 and the pre-fetch threshold. According to design requirements, the status information may include a count value indicating a number of normal read requests that have been transmitted to the memory controller 120 but the target data has not been yet obtained. The pre-fetch threshold is a threshold count value for the pre-fetch controller 290 to determine whether to send a pre-fetch request. For example, when the count value is greater than the pre-fetch threshold, it indicates that the memory controller 120 is in a busy state, so the pre-fetch controller 290 determines that the pre-fetch request is not sent to the memory controller 120, so as not to burden the memory controller 120. Conversely, when the count value is less than the pre-fetch threshold, it means that the memory controller 120 is in an idle state, so the pre-fetch controller 290 determines that the pre-fetch request can be sent to the memory controller 120. The pre-fetch controller 290 may cause the memory controller 120 to execute the normal read request of the external device 10 with high priority, and utilize the memory controller 120 to execute a pre-fetch request when the memory controller 120 is in an idle state to reduce the probability that the normal read request is delayed.

The pre-fetch threshold can be determined according to design requirements. In an embodiment, the pre-fetch controller 290 may count the pre-fetch hit rate. The “pre-fetch hit rate” refers to the statistical value of the target data of the normal read request being the same as the pre-fetch data. The pre-fetch controller 290 can dynamically adjust the pre-fetch threshold based on the pre-fetch hit rate. If the pre-fetch hit rate counted by the pre-fetch controller 290 is higher, it means that the pre-fetching efficiency of the pre-fetch accelerator circuit 110 is high at the time, so the pre-fetch controller 290 may raise the pre-fetch threshold to make the pre-fetch controller 290 easier to send a pre-fetch request to the memory controller 120. Conversely, if the pre-fetch hit rate counted by the pre-fetch controller 290 is lower, it means that the pre-fetching efficiency of the pre-fetch accelerator circuit 110 is low at the time, so the pre-fetch controller 290 may lower the pre-fetch threshold to make the pre-fetch controller 290 not easy to send a pre-fetch request to the memory controller 120 to avoid pre-fetching useless data from the memory 150.

For example, in some embodiments, the pre-fetch threshold includes a first threshold and a second threshold, wherein the second threshold is greater than or equal to the first threshold. When the pre-fetch hit rate is lower than the first threshold, it means that the pre-fetch hit rate is low at the time, so the pre-fetch controller 290 may lower the pre-fetch threshold, so that the pre-fetch controller 290 is not easy to send a pre-fetch request to the memory controller 120. When the pre-fetch hit rate is greater than the second threshold, it means the pre-fetching hit rate is high at the time, so the pre-fetch controller 290 may increase the pre-fetch threshold, so that the pre-fetch controller 290 can easily send the pre-fetch request to the memory controller 120.

When the normal request queue 230 does not have a normal read request, and the status information (e.g., the count value) is less than the pre-fetch threshold (i.e., the memory controller 120 is in an idle state), the pre-fetch controller 290 may send the pre-fetch request to the memory controller 120. Therefore, the pre-fetch controller 290 may utilize the memory controller 120 to perform the pre-fetch request when the memory controller 120 is in an idle state. When the normal request queue 230 has the normal read request, or the status information is not less than the pre-fetch threshold (i.e., the memory controller 120 may be busy), the pre-fetch controller 290 does not send a pre-fetch request to the memory to allow the memory controller 120 to execute the normal read request of the external device 10 with high priority.

The pre-fetch controller 290 may dynamically adjust the pre-fetch threshold based on the pre-fetch hit rate. According to design requirements, the pre-fetch hit rate may include a first count value, a second count value, and a third count value. The pre-fetch controller 290 may include a pre-fetch hit counter (not shown), a buffer hit counter (not shown), and a queue hit counter (not shown). The pre-fetch hit counter may count the number of times the normal read request hits the pre-fetch address of the pre-fetch request (i.e., the number of times the target address of the normal read request is the same as the pre-fetch address of the pre-fetch request) to obtain the first count value. The buffer hit counter may count the number of times the normal read request hits the pre-fetch data in the buffer 210 (i.e., the number of times the target address of the normal read request is the same as the pre-fetch address of any of the pre-fetch data in the buffer 210), as to obtain the second count value.

Referring to FIG. 4, the sent pre-fetch request queue 250 is coupled to the pre-fetch controller 290. The sent pre-fetch request queue 250 may record a pre-fetch request that has been sent to the memory controller 120 but the pre-fetch data has not been replied by the memory controller. According to design requirements, the sent pre-fetch request queue 250 can be a first-in-first-out buffer or other type of buffer. The queue hit counter may count the number of times the normal read request hits the pre-fetch address of the pre-fetch request in the sent pre-fetch request queue 250 (i.e., the target address of the normal read request is the same as the number of pre-fetch addresses of any one pre-fetch request in the sent pre-fetch request queue 250), so as to obtain the third count value.

In an embodiment, when the first count value is greater than the first threshold, the second count value is greater than the second threshold, and the third count value is greater than the third threshold (representing a high pre-fetch hit rate of the pre-fetch controller 290 at the time), and the pre-fetch controller 290 may increase the pre-fetch threshold. The first threshold, the second threshold, and/or the third threshold may be determined according to design requirements. When the first count value is less than the first threshold, the second count value is less than the second threshold, and the third count value is less than the third threshold (representing a low pre-fetch hit rate of the pre-fetching controller 290 at the time), the pre-fetch controller 290 can reduce the pre-fetch threshold.

In the embodiment shown in FIG. 4, the pre-fetch controller 290 includes a pre-fetch request address determiner 260, a pre-fetch request queue 270, and a pre-fetch arbiter 280. The pre-fetch request address determiner 260 is coupled to the interface circuit 130. The pre-fetch request address determiner 260 may perform the pre-fetch method shown in FIG. 2 to determine the address of the pre-fetch request. The pre-fetch request queue 270 is coupled to the pre-fetch request address determiner 260 to store the pre-fetch request issued by the pre-fetch request address determiner 260. According to design requirements, the pre-fetch request queue 270 can be a first-in-first-out buffer or other type of buffer. The pre-fetch arbiter 280 is coupled between the pre-fetch request queue 270 and the memory controller 120. The pre-fetch arbiter 280 may determine whether to send the pre-fetch request in the pre-fetch request queue 270 to the memory controller 120 according to the relationship between the status information (e.g., the count value) and the pre-fetch threshold.

In the embodiment, the pre-fetched arbiter 280 may count the pre-fetch hit rate. The pre-fetched arbiter 280 may dynamically adjust the pre-fetch threshold based on the pre-fetch hit rate. If the pre-fetch hit rate counted by the pre-fetch arbiter 280 is higher, the pre-fetch arbiter 280 may raise the pre-fetch threshold, that is, the pre-fetch request in the pre-fetch request queue 270 is more easily sent to the memory controller 120. If the pre-fetch hit rate counted by the pre-pre-fetch arbiter 280 is lower, the pre-fetch arbiter 280 may lower the pre-fetch threshold, that is, the pre-fetch request in the pre-fetch request queue 270 is not easily sent to the memory controller 120.

The pre-fetch accelerator circuit 110 shown in FIG. 4 further includes a sent normal request queue 240. The sent normal request queue 240 is configured to record a normal read request that has been sent to the memory controller 120 but the target data has not been replied by the memory controller. According to design requirements, the sent normal request queue 240 can be a first-in-first-out buffer or other type of buffer. When the pre-fetch request address determiner 260 of the pre-fetch controller 290 generates a pre-fetch request, the pre-fetch request address determiner 260 may determine whether to push the pre-fetch request into the pre-fetch request queue 270 according to the pre-fetch request queue 270, the normal request queue 230, the sent normal request queue 240, the sent pre-fetch request queue 250 and the buffer 210.

For example, after the pre-fetch request address determiner 260 generates a pre-fetch request (referred to herein as a candidate pre-fetch request), the pre-fetch request address determiner 260 may check the pre-fetch request queue 270, the normal request queue 230, the sent normal request queue 240, the sent pre-fetch request queue 250 and the buffer 210. When the pre-fetch request hits any of the pre-fetch request queue 270, the normal request queue 230, the sent normal request queue 240, the sent pre-fetch request queue 250, and the buffer 210 (i.e., an address of the pre-fetch request is the same as the address of any request in the pre-fetch request queue 270, the normal request queue 230, the sent normal request queue 240 and the sent pre-fetch request queue 250, or the pre-fetch request address is the same as the address corresponding to the pre-fetch data in the buffer 210), the pre-fetch request address determiner 260 may discard the candidate pre-fetch request (pre-fetch address). Conversely, the pre-fetch request address determiner 260 may push the candidate pre-fetch request (pre-fetch address) into the pre-fetch request queue 270.

Considering a capacity of the pre-fetch request queue 270 may be limited, when the candidate pre-fetch request is to be pushed into the pre-fetch request queue 270, if the pre-fetch request queue 270 is full, the pre-fetch request (the oldest pre-fetch request) in the front end of the pre-fetch request queue 270 can be discarded, and then the candidate pre-fetch request is pushed into the pre-fetch request queue 270.

The pre-fetch accelerator circuit 110 shown in FIG. 4 further includes a pending normal request queue 220. The pending normal request queue 220 is coupled to the interface circuit 130. The pending normal request queue 220 may store normal read requests. According to design requirements, the pending normal request queue 220 can be a first-in-first-out buffer or other type of buffer. When the buffer 210 does not have the target data of the normal read request of the external device 10, the pre-fetch controller 290 may check whether the normal read request hits the address of the pre-fetch request in the sent pre-fetch request queue 250. When the normal read request hits the address of a corresponding pre-fetch request in the sent pre-fetch request queue 250, the pre-fetch controller 290 pushes the normal read request into the pending normal request queue 220. After the pre-fetch data corresponding to the pre-fetch request is placed in the buffer 210, the pre-fetch controller 290 will return the target data in the buffer 210 to the interface circuit 130 according to the normal read request in the pending normal request queue 220.

Considering the capacity of the buffer 210 may be limited, when the new pre-fetch data is to be placed in the buffer 210, if the buffer 210 is full, the oldest pre-fetch data in the buffer 210 can be discarded, and then the new pre-fetch data is placed into the buffer 210. In addition, after a corresponding pre-fetch data (target data) is transmitted from the buffer 210 to the interface circuit 130 according to the normal read request, the corresponding pre-fetch data in the buffer 210 can be discarded.

When the normal read request does not hit the address of the pre-fetch request in the sent pre-fetch request queue 250, the pre-fetch controller 290 may check whether the normal read request hits the address of the pre-fetch request in the pre-fetch request queue 270 (step S560). When the normal read request hits the address of the pre-fetch request in the pre-fetch request queue 270, the pre-fetch controller 290 may delete the pre-fetch request with the same address as the normal read request in the pre-fetch request queue 270 (step S570), and the pre-fetch controller 290 may push the normal read request into the normal request queue 230 (step S580). When the normal read request does not hit the address of the pre-fetch request in the pre-fetch request queue 270, the pre-fetch controller 290 may push the normal read request into the normal request queue 230 (step S580).

An exemplary embodiment of an algorithm for the pre-fetch request address determiner 260 will be described below. For convenience of explanation, it is assumed that an address has 40 bits, 28 most significant bits (MSBs) (i.e., the 39th to the 12th bits) are defined as the base address, 6 least significant bits (LSBs) (i.e., The 5th to 0th bits) are defined as fine addresses, and the 11th to 6th bits are defined as index. In any case, the above address bits are defined as illustrative examples and should not be used to limit the disclosure. A base address may correspond to a 4K memory page, where the 4K memory page is defined as 64 cache lines. An index may correspond to a cache line.

The pre-fetch request address determiner 260 may establish a limited number of training address groups (also referred to as entries). The number of training address groups can be determined according to design requirements. For example, the upper limit number of training address groups can be 16. A training address group may correspond to a base address, which is, corresponding to a 4K memory page. The pre-fetch request address determiner 260 can manage the training address groups in accordance with the “least recently used (LRU)” algorithm. When the interface circuit 130 provides a current address of the normal read request of the external device 10 to the pre-fetch request address determiner 260, the pre-fetch request address determiner 260 may add the current address to the corresponding training address group (entry) according to a base address of the current address. All addresses in a same training address group (entry) have the same base address. When the current address does not have a corresponding training address group (entry), the pre-fetch request address determiner 260 may create a new training address group (entry) and then add the current address to the new training address group (entry). When the current address does not have a corresponding training address group (entry), and the number of training address groups has reached the upper limit, the pre-fetch request address determiner 260 may clear/remove the training address group (entry) that has not been accessed for the longest time and then create a new training address group (entry) to add the current address to the new training address group (entry).

Each training address group (entry) is configured with the same number of flags (or bitmask) as the number of cache lines. For example, when a training address group (entry) corresponds to 64 cache lines, the training address group (entry) is configured with 64 flags. A flag may indicate whether a corresponding cache line has been pre-fetched, or if the corresponding cache line has been read by a normal read request of the external device 10. The initial values of the flags are all 0 to indicate that they have not been pre-fetched. The pre-fetch request address determiner 260 may calculate the pre-fetch address according to a plurality of strides and the flags (detailed later).

After the pre-fetch request address determiner 260 adds the current address of the normal read request of the external device 10 as a new training address to a corresponding training address group (entry), the pre-fetch request address determiner 260 may reorder all training addresses in the corresponding training address group (entry). For example, the pre-fetch request address determiner 260 reorders the index for a plurality of training addresses in a same training address group (entry) in an up/down manner.

For example, external device 10 issues a normal read request with an address A, a normal read request with an address B, and a normal read request with an address C to the interface circuit 130 at different times. It is assumed that the address A, the address B and the address C have the same base address, so the address A, the address B and the address C are added to the same training address group (entry). However, a size relationship between the address A, the address B, and the address C may be unordered. Therefore, the pre-fetch request address determiner 260 may reorder the index of all training addresses (including the address A, the address B, and the address C) of the training address group (entry). It is assumed that a value of the index of the address A is 0, a value of the index of the address B is 3, and a value of the index of the address C is 2. Before reordering, the order of the indexes of the training addresses of the training address group (entry) is 0, 3, 2. After the pre-fetch request address determiner 260 reorders the indexes of the address A, the address B, and the address C, the order of the indexes of the training addresses of the training address group (entry) becomes 0, 2, 3.

After the reordering is completed, the pre-fetch request address determiner 260 may identify the maximum training address and the minimum training address among the plurality of training addresses of the same training address group that are reordered. Each training address group (entry) is also configured with a maximum address change counter and a minimum address change counter. In a same training address group (entry), the pre-fetch request address determiner 260 may use the maximum address change counter to count the number of variation times of the maximum training address to obtain a maximum address count value, and the minimum address count value is obtained by counting the number of variation times of the minimum training address by using the minimum address change counter. The pre-fetch request address determiner 260 may determine an address variation trend of the normal read request according to the maximum address count value and the minimum address count value.

For example, when the maximum address count value is greater than the minimum address count value, the pre-fetch request address determiner 260 may determine that the address variation trend of the normal read request of the external device 10 is an incremental trend. When the maximum address count value is less than the minimum address count value, the pre-fetch request address determiner 260 may determine that the address variation trend of the normal read request of the external device 10 is a declining trend.

Considering the capacity of a training address group (entry) (i.e., the number of training addresses in the same training address group) may be limited, when the number of a plurality of training addresses of the reordered training address group (entry) exceeds a first quantity and the address variation trend of the normal read request is an incremental trend, the pre-fetch request address determiner 260 may delete the minimum training address of the plurality of training addresses in the reordered training address group (entry). The first quantity can be determined according to design requirements. For example, in some embodiments, the first quantity can be seven or other quantities. When the number of the plurality of training addresses of the reordered training address group (entry) exceeds the first quantity and the address variation trend of the normal read request is a declining trend, the pre-fetch request address determiner 260 may delete the maximum training address of the plurality of training addresses in the reordered training address group (entry).

The pre-fetch request address determiner 260 may subtract any two adjacent training addresses of the training addresses of the reordered training address group (entry) to calculate a plurality of strides. For example, when the address variation trend of the normal read request of the external device 10 is the incremental trend, the pre-fetch request address determiner 260 may subtract a low address from a high address in any two adjacent training addresses to obtain the plurality of strides. When the address variation trend of the normal read request of the external device 10 is the declining trend, the pre-fetch request address determiner 260 may subtract the high address from the low address in any two adjacent training addresses to obtain the plurality of strides.

Table 1 illustrates a process of reordering the training addresses in the same training address group (entry) and the change in the count value.

TABLE 1

| | | | | | | | | Maximum | Minimum |
|---|---|---|---|---|---|---|---|---|---|
| | | | | | | | | address | address |
| Time | Training address group (entry) | | | | | | | count value | count value |
| T1 | 0 | | | | | | | 0 | 0 |
| T2 | 0 | 3 | | | | | | 1 | 0 |
| T3 | 0 | 3 | 2 | | | | | 1 | 0 |
| T4 | 0 | 2 | 3 | | | | | 1 | 0 |
| T5 | 0 | 2 | 3 | 5 | | | | 2 | 0 |
| T6 | 0 | 2 | 3 | 5 | 1 | | | 2 | 0 |
| T7 | 0 | 1 | 2 | 3 | 5 | | | 2 | 0 |
| T8 | 0 | 1 | 2 | 3 | 5 | 7 | | 3 | 0 |
| T9 | 0 | 1 | 2 | 3 | 5 | 7 | 4 | 3 | 0 |
| T10 | 0 | 1 | 2 | 3 | 4 | 5 | 7 | 3 | 0 |

Please refer to FIG. 4 and Table 1. At time T1, the pre-fetch request address determiner 260 creates a new training address group (entry), and then adds the training address with index 0 to the new training address group (entry), as shown in Table 1. At this time, count values (that is, the maximum address count value and the minimum address count value) of the maximum address change counter and the minimum address change counter of the training address group (entry) are initialized to zero. The external device 10 issues a new normal read request to the interface circuit 130, and the pre-fetch request address determiner 260 adds a current address of the new normal read request as a new training address to the training address group (entry) at time T2 as shown in Table 1. Assume that the current address has an index of 3. At this time, a maximum training address (maximum index) in the training address group (entry) is changed from 0 to 3, and a minimum training address (minimum index) remains at 0. Since the maximum training address (maximum index) has changed, the count value of the maximum address change counter (maximum address count value) is incremented by one.

The external device 10 issues another new normal read request to the interface circuit 130, and the pre-fetch request address determiner 260 adds the current address of the new normal read request as another new training address to the training address group (entry) shown in Table 1 at time T3. It is assumed that the current address has an index of 2. Next, at time T4, the pre-fetch request address determiner 260 reorders the training address group (entry). Since the maximum training address (maximum index) and the minimum training address (minimum index) in the training address group (entry) do not change, the maximum address count value remains at 1, and the minimum address count value remains at 0.

The external device 10 issues another new normal read request to the interface circuit 130, and the pre-fetch request address determiner 260 adds the current address of the new normal read request to another new training address in the training address group (entry) shown in Table 1 at time T5. It is assumed that the current address has an index of 5. At this time, the maximum training address (maximum index) in the training address group (entry) is changed from 3 to 5, and the minimum training address (minimum index) remains at 0. Since the maximum training address (maximum index) has changed, the count value of the maximum address change counter (maximum address count value) is incremented by 1, so the maximum address count value becomes 2.

The external device 10 issues a new normal read request to the interface circuit 130, and the pre-fetch request address determiner 260 adds the current address of the new normal read request to another new training address in the training address group (entry) shown in Table 1 at time T6. It is assumed that the current address has an index of 1. Next, at time T7, the pre-fetch request address determiner 260 reorders the training address group (entry). Since the maximum training address (maximum index) and the minimum training address (minimum index) in the training address group (entry) do not change, the maximum address count value remains at 2, and the minimum address count value remains at 0.

The external device 10 issues another new normal read request to the interface circuit 130, and the pre-fetch request address determiner 260 adds the current address of the new normal read request to another new training address in the training address group (entry) shown in Table 1 at time T8. It is assumed that the current address has an index of 7. At this time, the maximum training address (maximum index) in the training address group (entry) is changed from 5 to 7, and the minimum training address (minimum index) remains at 0. Since the maximum training address (maximum index) has changed, the count value of the maximum address change counter (maximum address count value) is incremented by 1, so that the maximum address count value becomes 3.

The external device 10 issues another new normal read request to the interface circuit 130, and the pre-fetch request address determiner 260 adds the current address of the new normal read request to another new training address in the training address group (entry) shown in Table 1 at time T9. It is assumed that the current address has an index of 4. Next, at time T10, the pre-fetch request address determiner 260 reorders the training address group (entry). At this time, the index (training address) of the reordered training address group is 0, 1, 2, 3, 4, 5, 7. Since the maximum training address (maximum index) and the minimum training address (minimum index) in the training address group (entry) do not change, the maximum address count value remains at 3, and the minimum address count value remains at 0.

The pre-fetch request address determiner 260 may determine the address variation trend of the normal read request based on the variation of the plurality of training addresses in the training address group (entry). Specifically, the pre-fetch request address determiner 260 may determine the address variation trend of the normal read request according to the count value of the maximum address change counter (the maximum address count value) and the count value of the minimum address change counter (the minimum address count value). When the maximum address count value is greater than the minimum address count value, the pre-fetch request address determiner 260 may determine that the address variation trend of the normal read request is the incremental trend (see the example shown in Table 1). When the maximum address count value is less than the minimum address count value, the pre-fetch request address determiner 260 may determine that the address variation trend of the normal read request is the declining trend.

Referring to Table 1, the plurality of indexes (training addresses) of the reordered training address group (entry) are sequentially 0, 1, 2, 3, 4, 5, 7. The address variation trend based on the example shown in Table 1 is an incremental trend, and the pre-fetch request address determiner 260 may obtain a plurality of strides by subtracting a low address from a high address in any two adjacent training addresses. Therefore, the pre-fetch request address determiner 260 may subtract the index values of any two adjacent addresses from low address to high address, and obtain a plurality of strides of 1−0=1, 2−1=1, 3−2=1, 4−3=1, 5−4=1, 7−5=2. In another embodiment, when the address variation trend of the normal read request is the declining trend, the pre-fetch request address determiner 260 may subtract a high address from a low address in any two adjacent training addresses to obtain a plurality of strides such that the strides are negative numbers.

After the pre-fetch request address determiner 260 obtains the plurality of strides, the pre-fetch request address determiner 260 may obtain the pre-fetch stride according to the strides. An acquisition method of the pre-fetch stride is described below.

After the pre-fetch request address determiner 260 obtains the plurality of strides, when the address variation trend of the normal read request is an incremental trend and three sequential strides of the plurality of strides are equal to a first stride value, the pre-fetch request address determiner 260 may use the first stride value as the pre-fetch stride, and obtain N addresses from the current addresses of the normal read request toward the high address direction as the pre-fetch addresses (a plurality of candidate pre-fetch addresses) according to the pre-fetch stride. The pre-fetch request address determiner 260 may check the flags corresponding to the plurality of candidate pre-fetch addresses (the flags of the cache lines). When the flags corresponding to the plurality of candidate pre-fetch addresses are not set (indicating that the plurality of candidate pre-fetch addresses have not been pre-fetched or accessed), the pre-fetch request address determiner 260 may obtain the addresses of the cache lines (the plurality of candidate pre-fetch addresses) as the pre-fetch addresses.

When the address variation trend of the normal read request of the external device 10 is a declining trend and there are three sequential strides in the plurality of strides equal to the first stride value, the pre-fetch request address determiner 260 may use the first stride value as the pre-fetching step, and obtain N addresses from the current addresses of the normal read request toward the low address direction as the pre-fetch addresses (a plurality of candidate pre-fetch addresses). The pre-fetch request address determiner 260 may check the flags corresponding to the plurality of candidate pre-fetch addresses (the flags of the cache lines). When the flags corresponding to the plurality of candidate pre-fetch addresses are not set (indicating that the plurality of candidate pre-fetch addresses have not been pre-fetched or accessed), the pre-fetch request address determiner 260 may obtain the addresses of the cache lines (the plurality of candidate pre-fetch addresses) as pre-fetch addresses.

The N can be determined according to design requirements. For example, in an embodiment, the N can be 3 or other quantities. The embodiment does not limit the numerical range of N. In other embodiments, the pre-fetch request address determiner 260 may dynamically adjust the number N of pre-fetch addresses based on a pre-fetch hit rate of the pre-fetch request. The “pre-fetch hit rate” refers to a statistical value of a normal read request hit pre-fetch data. The “pre-fetch hit rate” is calculated by the pre-fetched arbiter 280, and has been described in detail above, and therefore will not be described herein.

The address variation trend based on the example shown in Table 1 is an incremental trend, and the plurality of strides are positive numbers. Taking Table 1 as an example, the plurality of strides are 1, 1, 1, 1, 1, 2. There exists the stride values of the three sequential strides equal to each other (all “1”) in the plurality of strides, so the pre-fetch request address determiner 260 may use “1” as the pre-fetch stride. The pre-fetch request address determiner 260 may obtain N (for example, 3) addresses from the current address of the current normal read request toward the high address direction by the stride “1” as the pre-fetch address.

After the pre-fetch request address determiner 260 obtains the plurality of strides, when there are no sequential three strides in the plurality of strides equal to the first stride value and there are two sequential strides equal to the second stride value, the pre-fetch request address determiner 260 may use the second stride value as the pre-fetch stride, and calculate the pre-fetch address of the pre-fetch request according to the pre-fetch stride and the current address of the normal read request. For example, assume that the plurality of strides are 1, 3, 3, 2, 1, 2 and the address variation trend of the normal read request is an incremental trend. There are two sequential strides in these strides that are equal to each other (all 3), so the pre-fetch request address determiner 260 can use the stride “3” as the pre-fetch stride. The pre-fetch request address determiner 260 may obtain N (for example, 3) addresses from the current address of the current normal read request toward the high address direction by the stride “3” as the pre-fetch address.

After the pre-fetch request address determiner 260 obtains the plurality of strides, when any two sequential strides of the plurality of strides are not equal to each other and the address of the normal read request of the external device 10 changes in an incremental trend, the pre-fetch request address determiner 260 may obtain the address (index) of the next cache line from the current address of the normal read request toward the high address direction as the pre-fetch address. The pre-fetch request address determiner 260 may obtain the address (index) of the next cache line from the current address of the normal read request toward the low address direction as the pre-fetch address when any two sequential strides of the plurality of strides are unequal to each other and the address variation trend of the normal read request of the external device 10 is a declining trend. For example, assume that the plurality of strides are 3, 1, 2, 4, 2, 1 and the address variation trend of the normal read request is an incremental trend. Any two sequential strides of these strides are not equal to each other, so the pre-fetch request address determiner 260 may obtain N addresses from the current address of the previous normal read request toward the high address direction as the pre-fetch address by the pre-fetch stride of 1.

After the pre-fetch request address determiner 260 obtains the pre-fetch stride, when the address variation trend of the normal read request of the external device 10 is an incremental trend, the pre-fetch request address determiner 260 may fetch/select the pre-fetch address from the current address of the normal read request toward the high address direction according to the pre-fetch stride. When the address variation trend of the normal read request of the external device 10 is a declining trend, the pre-fetch request address determiner 260 may fetch/select the pre-fetch address from the current address of the normal read request toward the low address direction according to the pre-fetch stride. After calculating the pre-fetch address, the pre-fetch request address determiner 260 may send a pre-fetch request to the pre-fetch request queue 270.

Based on above, the memory integrated circuit and its pre-fetch address determining method as mentioned in various embodiments of the present invention may optimize the performance of the bandwidth of the memory. Under the circumstance that the external device 10 issues the plurality of the normal read requests to the memory integrated circuit in the manner that the address is unordered (out-of-order), the memory integrated circuit may serve use the addresses of these normal read requests as the training addresses and reorder the training addresses to calculate the pre-fetch stride. The memory integrated circuit may calculate the pre-fetch address according to the pre-fetch stride and the current address of the current normal read request. Therefore, the memory integrated circuit may reduce the impact of the out-of-order (unordered) addresses on the estimation of the pre-fetch address and improve the pre-fetch hit rate.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory integrated circuit, comprising:
an interface circuit, configured to receive a normal read request of an external device;
a memory;
a memory controller, coupled to the memory;
a pre-fetch accelerator circuit, coupled between the interface circuit and the memory controller to be configured to generate a pre-fetch request,
wherein when the pre-fetch accelerator circuit receives the normal read request from the interface circuit, the pre-fetch accelerator circuit adds a current address of the normal read request to a training address group, reorders a plurality of training addresses of the training address group, calculates a pre-fetch stride according to the plurality of training addresses of the reordered training address group, and calculates a pre-fetch address of the pre-fetch request based on the pre-fetch stride and the current address.

2. The memory integrated circuit as claimed in claim 1, wherein the pre-fetch accelerator circuit determines an address variation trend of the normal read request according to a variation of the plurality of training addresses of the training address group.

3. The memory integrated circuit as claimed in claim 2, wherein the plurality of training addresses of the reordered training address group have a maximum training address and a minimum training address, and the pre-fetch accelerator circuit counts variation times of the maximum training address to obtain a maximum address count value, counts variation times of the minimum training address to obtain a minimum address count value, and determines the address variation trend of the normal read request according to the maximum address count value and the minimum address count value.

4. The memory integrated circuit as claimed in claim 3, wherein the pre-fetch accelerator circuit determines the address variation trend of the normal read request as an incremental trend when the maximum address count value is more than the minimum address count value, and the pre-fetch accelerator circuit determines the address variation trend of the normal read request as a declining trend when the maximum address count value is less than the minimum address count value.

5. The memory integrated circuit as claimed in claim 2, wherein the pre-fetch accelerator circuit obtains the pre-fetch address from the current address toward a high address direction based on the pre-fetch stride when the address variation trend of the normal read request is the incremental trend, and the pre-fetch accelerator circuit obtains the pre-fetch address from the current address toward a low address direction based on the pre-fetch stride when the address variation trend of the normal read request is the declining trend.

6. The memory integrated circuit as claimed in claim 2, wherein the pre-fetch accelerator circuit deletes a minimum training address in the plurality of training addresses of the reordered training address group when a number of the plurality of training addresses of the reordered training address group is more than a first number and the address variation trend of the normal read request is an incremental trend, and the pre-fetch accelerator circuit deletes a maximum training address in the plurality of training addresses of the reordered training address group when the number of the plurality of training addresses of the reordered training address group is more than the first number and the address variation trend of the normal read request is a declining trend.

7. The memory integrated circuit as claimed in claim 1, wherein the pre-fetch accelerator circuit calculates a plurality of strides by subtracting any two adjacent training addresses in the plurality of training addresses of the reordered training address group.

8. The memory integrated circuit as claimed in claim 7, wherein the pre-fetch accelerator circuit obtains the plurality of strides by subtracting a low address from a high address in the any two adjacent training addresses when an address variation trend of the normal read request is an incremental trend, and the pre-fetch accelerator circuit obtains the plurality of strides by subtracting the high address from the low address in the any two adjacent training addresses when the address variation trend of the normal read request is a declining trend.

9. The memory integrated circuit as claimed in claim 7, wherein the pre-fetch accelerator circuit sets the first stride value as the pre-fetch stride and obtains N addresses as the pre-fetch address from the current address toward a high address direction based on the pre-fetch stride when an address variation trend of the normal read request is an incremental trend and the plurality of strides having three sequential strides equal to a first stride value, and the pre-fetch accelerator circuit sets the first stride value as the pre-fetch stride and obtains N addresses as the pre-fetch address from the current address toward a low address direction based on the pre-fetch stride when the address variation trend of the normal read request is a declining trend and the plurality of strides having three sequential strides equal to the first stride value.

10. The memory integrated circuit as claimed in claim 9, wherein the pre-fetch accelerator circuit adjusts dynamically a number N of the pre-fetch address according to a pre-fetch hit rate of the pre-fetch request.

11. The memory integrated circuit as claimed in claim 7, wherein the pre-fetch accelerator circuit sets a second stride value as the pre-fetch stride and calculates the pre-fetch address of the pre-fetch request according to the pre-fetch stride and the current address when the plurality of strides having no three sequential strides equal to a first stride value and having two sequential strides equal to the second stride value.

12. The memory integrated circuit as claimed in claim 7, wherein the pre-fetch accelerator circuit obtains an address of a next cache line as the pre-fetch address from the current address toward a high address direction when any two sequential strides in the plurality of strides are not equal to each other and an address variation trend of the normal read request is an incremental trend, and the pre-fetch accelerator circuit obtains the address of the next cache line as the pre-fetch address from the current address toward a low address direction when the any two sequential strides in the plurality of strides are not equal to each other and the address variation trend of the normal read request is a declining trend.

13. The memory integrated circuit as claimed in claim 7, wherein a plurality of flags is configured to mark whether addresses of a plurality of cache lines are pre-fetched, and the pre-fetch accelerator circuit calculates the pre-fetch address according to the plurality of strides and the plurality of flags.

14. The memory integrated circuit as claimed in claim 13, wherein the pre-fetch accelerator circuit checks the flag of a next cache line from the current address toward a high address direction when an address variation trend of the normal read request is an incremental trend, the pre-fetch accelerator circuit checks the flag of the next cache line from the current address toward a low address direction when the address variation trend of the normal read request is a declining trend, and the pre-fetch accelerator circuit obtains an address of the next cache line as the pre-fetch address when the flag is not set.

15. A pre-fetch address determining method is applicable for a memory integrated circuit, and the pre-fetch address determining method comprising:
adding, by a pre-fetch accelerator circuit of the memory integrated circuit, a current address of a normal read request to a training address group when an interface circuit of the memory integrated circuit receives the normal read request of an external device;
reordering, by the pre-fetch accelerator circuit, a plurality of training addresses of the training address group after the current address is added to the training address group;
calculating, by the pre-fetch accelerator circuit, a pre-fetch stride according to the plurality of training addresses of the reordered training address group; and
calculating, by the pre-fetch accelerator circuit, a pre-fetch address of a pre-fetch request by the pre-fetch accelerator circuit based on the pre-fetch stride and the current address.

16. The pre-fetch address determining method as claimed in claim 15, further compressing:
determining, by the pre-fetch accelerator circuit, an address variation trend of the normal read request according to a variation of the plurality of training addresses of the training address group.

17. The pre-fetch address determining method as claimed in claim 16, wherein the plurality of training addresses of the reordered training address group have a maximum training address and a minimum training address, and the step of determining the address variation trend of the normal read request comprising:
counting, by the pre-fetch accelerator circuit, variation times of the maximum training address to obtain a maximum address count value;
counting, by the pre-fetch accelerator circuit, variation times of the minimum training address to obtain a minimum address count value; and
determining, by the pre-fetch accelerator circuit, the address variation trend of the normal read request according to the maximum address count value and the minimum address count value.

18. The pre-fetch address determining method as claimed in claim 17, wherein the step of determining the address variation trend of the normal read request according to the maximum address count value and the minimum address count value comprising:
determining, by the pre-fetch accelerator circuit, the address variation trend of the normal read request as an incremental trend when the maximum address count value is more than the minimum address count value; and
determining, by the pre-fetch accelerator circuit, the address variation trend of the normal read request as a declining trend when the maximum address count value is less than the minimum address count value.

19. The pre-fetch address determining method as claimed in claim 16, wherein the step of calculating the pre-fetch address of the pre-fetch request comprising:
obtaining, by the pre-fetch accelerator circuit, the pre-fetch address from the current address toward a high address direction based on the pre-fetch stride when the address variation trend of the normal read request is the incremental trend; and
obtaining, by the pre-fetch accelerator circuit, the pre-fetch address from the current address toward a low address direction based on the pre-fetch stride when the address variation trend of the normal read request is the declining trend.

20. The pre-fetch address determining method as claimed in claim 16, further compressing:
deleting, by the pre-fetch accelerator circuit, a minimum training address in the plurality of training addresses of the reordered training address group when a number of the plurality of training addresses of the reordered training address group is more than a first number and the address variation trend of the normal read request is an incremental trend; and
deleting, by the pre-fetch accelerator circuit, a maximum training address in the plurality of training addresses of the reordered training address group when the number of the plurality of training addresses of the reordered training address group is more than the first number and the address variation trend of the normal read request is a declining trend.

21. The pre-fetch address determining method as claimed in claim 15, wherein the step of calculating the pre-fetch stride comprising:
calculating, by the pre-fetch accelerator circuit, a plurality of strides by subtracting any two adjacent training addresses in the plurality of training addresses of the reordered training address group.

22. The pre-fetch address determining method as claimed in claim 21, wherein the step of calculating the plurality of strides comprising:
obtaining, by the pre-fetch accelerator circuit, the plurality of strides by subtracting a low address from a high address in the any two adjacent training addresses when an address variation trend of the normal read request is an incremental trend; and
obtaining, by the pre-fetch accelerator circuit, the plurality of strides by subtracting the high address from the low address in the any two adjacent training addresses when the address variation trend of the normal read request is an incremental trend.

23. The pre-fetch address determining method as claimed in claim 21, wherein the step of calculating the pre-fetch stride further comprising:
obtaining, by the pre-fetch accelerator circuit, N addresses as the pre-fetch address from the current address toward a high address direction based on a first stride value when an address variation trend of the normal read request is an incremental trend and the plurality of strides having three sequential strides equal to the first stride value; and
obtaining, by the pre-fetch accelerator circuit, N addresses as the pre-fetch address from the current address toward a low address direction based on the first stride value when the address variation trend of the normal read request is a declining trend and the plurality of strides having three sequential strides equal to the first stride value.

24. The pre-fetch address determining method as claimed in claim 23, further compressing:
dynamically adjusting, by the pre-fetch accelerator circuit, a number N of the pre-fetch address according to a pre-fetch hit rate of the pre-fetch request.

25. The pre-fetch address determining method as claimed in claim 21, wherein the step of calculating the pre-fetch stride further comprising:
calculating, by the pre-fetch accelerator circuit, the pre-fetch address of the pre-fetch request according to a second stride value and the current address when the plurality of strides having no three sequential strides equal to a first stride value and having two sequential strides equal to the second stride value.

26. The pre-fetch address determining method as claimed in claim 21, wherein the step of calculating the pre-fetch stride further comprising:
obtaining, by the pre-fetch accelerator circuit, an address of a next cache line as the pre-fetch address from the current address toward a high address direction when any two sequential strides in the plurality of strides are not equal to each other and an address variation trend of the normal read request is an incremental trend; and
obtaining, by the pre-fetch accelerator circuit, the address of the next cache line as the pre-fetch address from the current address toward a low address direction when the any two sequential strides in the plurality of strides are not equal to each other and the address variation trend of the normal read request is a declining trend.

27. The pre-fetch address determining method as claimed in claim 21, wherein a plurality of flags is configured to mark whether addresses of a plurality of cache lines are pre-fetched, and the step of calculating the pre-fetch stride further comprising:
calculating, by the pre-fetch accelerator circuit, the pre-fetch address according to the plurality of strides and the plurality of flags.

28. The pre-fetch address determining method as claimed in claim 27, wherein the step of calculating the pre-fetch address according to the plurality of strides and the plurality of flags comprising:
checking, by the pre-fetch accelerator circuit, the flag of a next cache line from the current address toward a high address direction when an address variation trend of the normal read request is an incremental trend;
checking, by the pre-fetch accelerator circuit, the flag of the next cache line from the current address toward a low address direction when the address variation trend of the normal read request is a declining trend; and
obtaining, by the pre-fetch accelerator circuit, an address of the next cache line as the pre-fetch address when the flag is not set.
